(19) United States
(12) Patent Application Publication
(10) Pub. No.: US 2011/0273438 A1
(43) Pub. Date: Nov. 10, 2011

(54) ELECTRONIC APPARATUS AND METHOD OF CHOOSING DATA THEREOF

(75) Inventors: HUA LIU, Taipei County (TW); Jen-Wei Chen, Taipei County (TW)

(73) Assignees: KINPO ELECTRONCIS, INC., Taipei County (TW); CAL-COMP ELECTRONICS & COMMUNICATIONS COMPANY LIMITED, Taipei County (TW)

(21) Appl. No.: 12/852,617

(22) Filed: Aug. 9, 2010

(30) Foreign Application Priority Data
May 10, 2010 (TW) 99114847

(51) Int. Cl. G06T 15/00

(52) U.S. Cl. 345/419

(57) ABSTRACT

An electronic apparatus and a method of choosing data thereof are provided. The electronic apparatus includes a display unit, a database and a play unit. The display unit is capable of displaying a three-dimensional (3D) diagram which is used to indicate a plurality of data categories. The outward appearance of the 3D diagram may be transformed in order to point to one of the data categories according to an input instruction. The play unit may read the corresponding multimedia data from the database according to the instruction and play it. The 3D diagram is preferably described by a pillar section, a ring section and a connecting section. The pillar section lies at a central region of the ring section and connects to the ring section via the connecting section.

### BACKGROUND OF THE INVENTION

1. Field of the Invention

The present invention relates to an electronic apparatus, in particular, to the electronic apparatus capable of playing multimedia and having an interface of data selection.

2. Description of Related Art

With the fast development of the manufacturing procedure of the semiconductor, the electronic products are getting more powerful and slimmer, and also bringing more convenience to people. For example, due to the applications of consumer electronics and network rise, the music playing devices, such as MP3 players, are getting widespread. The iPod, manufactured by Apple(™) Inc., becomes the most popular player. This kind of music player particularly provides an easy-to-use user interface. The user interface of the iPod allows a user to manipulate the functions via a central roller, and also provides storage with large capacity for storing a great number of multimedia files.

Due to the iPod's commercial success, the current development of the music players tends to have light and thin size, and large capacity of the storage. The modern music players have sufficient capacity that may contain thousands of music files. Although the great number of music files may be stored into a music player, however, the music may merely be categorized by the album's titles or/and singers. The user may need to click a specified category to play the music, but not the selected category by following some indicators. The conventional music players may disturb the users when they select the music from the mass files since the player may not provide the more convenient solution.

Furthermore, the mass music files may be stored in a personal computer or any network storage. However, most players do not provide essential solution when the users make the selections from the music files, such as comprehensive or more convenient user interface that is provided for accurate selection made by users.

### SUMMARY OF THE INVENTION

In view of the drawbacks of the conventional schemes, provided is an electronic apparatus in accordance with the present invention, and a method of choosing data. The invention features that the electronic apparatus is particularly correlated with a database and a humanized user interface. Thus the multimedia file may be accurately selected by expediting acknowledgement of the user's request. In which, the user interface provided in the electronic apparatus employs a variety of parameters of categories which separately indicate the different data categories. When the user needs to select a specific music file in accordance with multiple conditions, the invention assists the user in searching the music category by means of a visual scheme, and therefore the further selection can be accelerated.

The claimed electronic apparatus substantially includes a display unit, a database, and a play unit. The display unit is particularly used for displaying a three-dimensional diagram. This three-dimensional diagram indicates a plurality of data categories, and its outward appearance can be transformed to point to one of the categories in accordance with an input instruction. The database stores a plurality of multimedia data. Those multimedia data separately corresponds to the data categories. Further, the play unit coupled to the display unit and the database will read the data from the category specified by the three-dimensional diagram, and play it afterwards.

In particular, the three-dimensional diagram is described by a pillar section, a ring section, and a connecting section. The pillar section lies in a central region, and connects to the ring section via the connecting section.

In one of the embodiments of the present invention, the multimedia data is particularly the music, and the play unit is preferably a music player. The pillar section includes a plurality of emotional indicators. The ring section has a plurality of music categories. The connecting section has a plurality of strength indicators. Preferably, the data categories may separately correspond to one of the emotional indicators, one of the music categories, and one of the strength indicators.

Further, the relative position among the pillar section, the ring section, and the connecting section of the three-dimensional diagram will be changed by referring to the input instruction. The display unit may include a touch panel for receiving the input instruction. Still further, any user may input the input instruction through a set of arrow keys of a keyboard unit, so as to control the three-dimensional diagram.

From the other point of view, a method of choosing data is further provided to adapt to the described electronic apparatus. The method thereof includes a first step of displaying the three-dimensional diagram on a display unit of the electronic apparatus. The three-dimensional diagram indicates a plurality of data categories, and its outward appearance will be transformed, in accordance with an input instruction, to point one of the data categories. The one data category specified by the three-dimensional diagram then correlates with a database, and he apparatus will read and play the corresponding multimedia data.

The described three-dimensional diagram is particularly described by a pillar section, a ring section, and a connecting section. The pillar section lies at the central region of the ring section, and connects to the ring section via the connecting section. The relative position of the pillar section, the ring section, and the connecting section of the three-dimensional diagram may also change according to the input instruction. Further detail of the data selection may refer to the above-described method of the electronic apparatus.

In summation, the present invention particularly integrates multiple parameters of categories into the three-dimensional diagram, and establishes a correlation between the parameters and the multimedia data in the database. A visual scheme used to describe the user interface is also provided, by which the user can conveniently use and manage the large number of music files. Furthermore, the invention expedites the process of input instructions for the electronic apparatus, and reaches a high accuracy of selection.

### BRIEF DESCRIPTION OF THE DRAWINGS

This invention may be practiced in certain physical forms and arrangements of the parts herein described, but a preferred embodiment of which will be described in detail in the specification and illustrated in the accompanying drawings which form a part hereof:

FIG. 1 shows a function diagram illustrate the first embodiment of the electronic apparatus in accordance with the present invention;

FIG. 2 shows a schematic diagram of the three-dimensional diagram in accordance with the first embodiment of the present invention;

FIG. 3 is a flow chart illustrating the method of choosing data in accordance with the second embodiment of the present invention.

### DESCRIPTION OF THE PREFERRED EMBODIMENTS

### First Embodiment

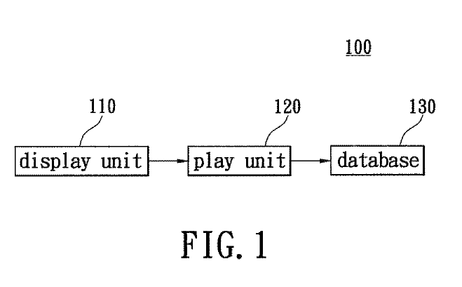

Reference is made to FIG. 1 illustrating a function block of the electronic apparatus in accordance with the first embodiment of the present invention. The electronic apparatus 100 mainly includes a display unit 110, a play unit 120, and a database 130. The play unit 120 is operatively coupled to the display unit 110 and the database 130. The database 130 contains the plural multimedia data, such as music, which is categorized in compliance with the data categories. The play unit 120 plays the music that is read from the database 130. Those data categories are defined in accordance with design requirements or people's request. The categories can be music types, rhythm strength, emotions and singers' names, groups, or individuals. However, the embodiment may not limit the present invention.

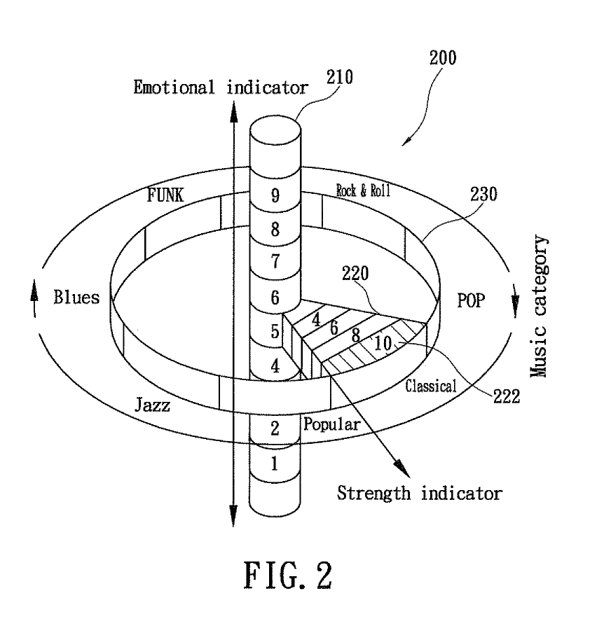

The display unit 110 displays a three-dimensional diagram. The three-dimensional diagram is described to indicate a plurality of data categories. In accordance with an input instruction, the outward appearance of three-dimensional diagram is transformed to point to the different data categories. Further reference is made to FIG. 2, which schematically depicts the three-dimensional diagram 200 in accordance with the first embodiment. The three-dimensional diagram 200 is particularly described by a pillar section 210, a ring section 230, and a connecting section 220. The pillar section 210 lies at a central region of the ring section 230, and connects to the ring section 230 via the connecting section 220.

The connecting section 220 and the ring section 230 may move upward, downward, and rotation along the pillar section 210 according to the user's manipulation. Furthermore, the user may also control the three-dimensional diagram 200 via a touch panel disposed in the display unit 110, or via a set of arrow keys. In which the pillar section 210, ring section 230, and the connecting section 220 of the three-dimensional diagram 200 are set by a plurality of classification parameters or indicators. The indicators may present an emotional indicator, music category, or strength indicator.

Reference is made to FIG. 2. The pillar section 210 indicates a level of an emotional indicator. The numbers 1 to 9 represent the different levels, such as an indicator of happiness. The higher number may represent the more positive or constructive music. On the contrary, the lower number may represent the more negative or destructive music. Further, the ring section 230 indicates the plurality of music categories, preferably including Pop, Classical, Rock & Roll, Funk, Blues, and Jazz music. The connecting section 220 further indicates the strength of music, such as the degrees describing the music rhythm.

According to the present invention, any user may make a selection of a data category by slipping or clicking his finger on a touch panel in order to spin the connecting section 220 and to move the ring section 230. The connecting section 220 may spin along an axis of the pillar section 210, and move upward and downward. The ring section 230 may move upward and downward by following movement of the connecting section 220. In particular, relative position among the mentioned pillar section 210, the connecting section 220, and ring section 230 of the three-dimensional diagram 200 can be transformed in accordance with the input instruction. Provided is a visualized user interface, which is easily manipulated.

Thus, the every user-selected data category may preferably correspond to three parameters, including emotional indicator, music category and strength indicator. The electronic apparatus 100 may further include a keyboard unit, by which the user uses a set of arrow keys (not shown) upon the keyboard unit to control the three-dimensional diagram 200 for selecting one of the categories. The way and device to input instruction of the embodiment in accordance with the present invention may not be limited by the above description.

The selected data category can be visualized by means of drawing a highlight zone, using shadow, or blinking. However, the preferred embodiment may not be limited herein. For an example of the data category 222, the data category 222 represents the emotional indicator numbered as 5, the music category is classical music, and the strength indicator is numbered as 10. When the user confirms the data category 222, the play unit 120, such as a music player, links to a database 130 and plays the multimedia reading from the database 130 according to the data category 222 pointed by the three-dimensional diagram 200. Such as the shown data category 222, the play unit 120 will play the classical music with high rhythm strength. Furthermore, the way to play the music may be configured to play the multimedia sequentially or randomly, or to arrange the playing schedule. However, the mentioned electronic apparatus 100 may provide a configuration menu for users. The configuration items may not be limited by the above description.

The described multimedia data in the database 130 may be categorized into the various indicators depicted by the three-dimensional diagram 200. Every combination of the indicators will correspond to at least one set of the multimedia data. While the user stores new data into the database 130, the new data will be categorized properly. It is worth noting that the play unit 120 and the database 130 may be, but not limited to, wired or wirelessly connected or interconnected via a network.

In one further embodiment of the present invention, the database 130 may be, but not limited to, implemented by a remote server, or alternatively by a hard disk or any storage memory.

The three-dimensional diagram 200, referring to FIG. 2, provided by the display unit 110 can be described by a cubic diagram. This cubic diagram allows the users conveniently to configure and make selection. Therefore, combination of the database and the user interface, namely the three-dimensional diagram 200, can speed up the selection for any file matched with the needs of users. Furthermore, the three-dimensional diagram 200 may additionally be combined with a variety of parameters provided for users' various selections. If the user needs to use several terms to make a selection of multimedia file, the 3D diagram 200 assists him to find out the related music category by means of a visual scheme. The scheme may speed up the procedure. Through this humanized user interface, the electronic apparatus 100 can thereby filter out the matched music category and play it. The present invention therefore can shorten the data selection procedure and simplify the complexity of category of the large number files.

It is noted that the present invention may not be limited to the 3D diagram shown in FIG. 2, exemplarily including the above-described emotional indicator, music category and strength indicator, which are the parameters indicating the pillar section 210, ring section 230 and the connecting section 220. The parameters may be modified or configured in accordance with the design requirements and user's need. It is generally featured that the three-dimensional diagram 200 is configured to correspond to the categories in database 120.

### Second Embodiment

A method of choosing data can be derived from the above-described embodiment. The method is particularly adapted to an electronic apparatus. References are made to FIGS. 1 through 3.

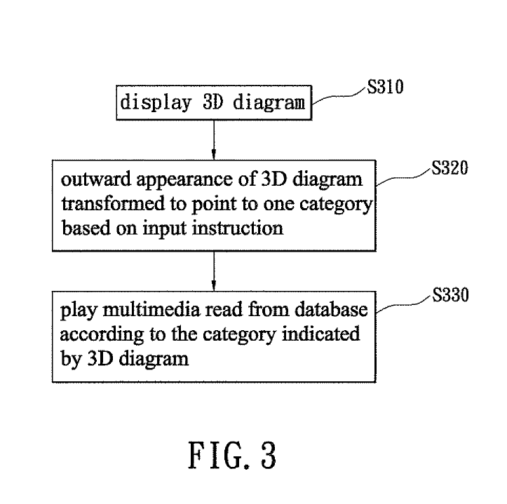

FIG. 3 depicts a flow chart of the method of choosing data in accordance with the second embodiment of the present invention. The first step in the method is to display a 3D diagram 200 (in FIG. 2) on the display unit 110 (step S310). The 3D diagram 200 indicates the plurality of data categories, and the outward appearance thereof is transformed to point to one of the categories according to a user's input instruction (step S320), for example, the data category 222. A multimedia data is then read from the database 130 in accordance with the data category specified by the 3D diagram 200. After that, the corresponding multimedia is played (step S330). The more details regarding the three-dimensional diagram 200 and the data selection method can be refereed to the first embodiment, and derived by the regular person of skill to which this invention pertains.

To sum up the above description, the present invention particularly employs a user interface depicted by a three-dimensional diagram which has plural indicators. Thus this three-dimensional diagram provides a user conveniently to select one of the data categories. By correlating the three-dimensional diagram with the data categories in database, the electronic apparatus may expedite the selection accurately, and play the selected multimedia.

It is worth noting that the electronic apparatus of the present invention may further include a keyboard unit, by which the user can use the set of arrow keys (not shown) to control the three-dimensional diagram to make any selection. It is also not to limit the way and apparatus to generate the input instruction.

The invention has been described using an exemplary preferred embodiment. However, it is to be understood that the scope of the invention is not limited to the disclosed embodiment. On the contrary, it is intended to cover various modifications and similar arrangements. The scope of the claims, therefore, should be accorded the broadest interpretation so as to encompass all such modifications and similar arrangements.

What is claimed is:

1. An electronic apparatus, comprising:
a display unit, used for displaying a three-dimensional diagram, which indicates a plurality of data categories, and outward appearance of the three-dimensional diagram transforms according to an input instruction and points to one of the data categories;
a database, used for storing a plurality of multimedia data which correspond to the data categories; and
a play unit, coupled to the display unit and the database, wherein the play unit plays one multimedia data corresponding to one data category pointed by the three-dimensional diagram and read from the database;
wherein, the three-dimensional diagram is described by a pillar section, a ring section, and a connecting section, and the pillar section lies at a central region of the ring section, and connects to the ring section via the connecting section.

2. The apparatus of claim 1, wherein the multimedia data is music, and the play unit is a music player.

3. The apparatus of claim 1, wherein the pillar section has a plurality of emotional indicators, the ring section has a plurality of music categories, and the connecting section has a plurality of strength indicators; the data category corresponds to one of the emotional indicators, one of the music categories, and one of the strength indicators.

4. The apparatus of claim 1, wherein the relative positions of the pillar section, the ring section and the connecting section are changed according to the input instruction.

5. The apparatus of claim 1, wherein the play unit connects to the database over a network.

6. The apparatus of claim 1, wherein the display unit includes a touch panel for receiving the input instruction.

7. The apparatus of claim 1, further comprising:
a keyboard unit having a set of arrow keys for receiving the input instruction.

8. A method of choosing data adapted to an electronic apparatus, comprising:
a display unit of the electronic apparatus displaying a three-dimensional diagram, which indicates a plurality of data categories, wherein the outward appearance of the three-dimensional diagram is transformed to point to one of the data categories according to an input instruction; and
linking to a database for reading and playing corresponding multimedia data in accordance with the data category pointed by the three-dimensional diagram;
wherein, the three-dimensional diagram is described by a pillar section, a ring section, and a connecting section, and the pillar section lies within a central range of the ring section, and connects to the ring section via the connecting section, wherein the relative position of the pillar section, the ring section and the connecting section of the three-dimensional diagram changes according to the input instruction.

9. The method of claim 8, wherein the multimedia data is music.

10. The method of claim 8, wherein the pillar section includes a plurality of emotional indicators, the ring section includes a plurality of music categories, and the connecting section includes a plurality of strength indicators, and the data category separately corresponds to one of the emotional indicators, one of the music categories, and one of the strength indicators.

11. The method of claim 8, wherein the step of the data category pointed by the three-dimensional diagram linked with the database further comprises a step of linking the database via a network.

12. The method of claim 8, wherein the input instruction is inputted through a touch panel.

13. The method of claim 8, wherein the input instruction is inputted through a set of arrow keys.
